(19) United States
(12) Patent Application Publication
(10) Pub. No.: US 2003/0055914 A1
(43) Pub. Date: Mar. 20, 2003

(54) Communication apparatus and method, recording medium, program, and content providing apparatus

(76) Inventor: Izuru Tanaka, Tokyo (JP)

Correspondence Address: Randy J. Pritzker, Wolf, Greenfield & Sacks, P.C., 600 Atlantic Avenue, Boston, MA, 02210, US

(21) Appl. No.: 10/210,183

(22) Filed: Aug. 1, 2002

(30) Foreign Application Priority Data
Aug. 1, 2001 (JP) P2001-233324

(51) Int. Cl. G06F 15/16

(52) U.S. Cl. 709/218; 709/219; 345/738

(57) ABSTRACT

The present invention is intended to provide a content providing system having a terminal and a server. The terminal includes a selector for selecting search information from presentation information presented to a user; a search information transmitter for transmitting the search information selected by the selecting means to the server; and a content data receiver for receiving content data corresponding to the search information supplied from the server. The server includes a storage device for storing the content data corresponding to the search information; a searcher for searching the storage means for the content data corresponding to the search information supplied from the search information transmitter of the terminal; and a content data transmitter for transmitting the content data retrieved from the storage information to the terminal. Consequently, the novel constitution allows the user to obtain content data with simple and easy operations.

### BACKGROUND OF THE INVENTION

The present invention relates generally to a communication apparatus and method, a recording medium, a program, and a content providing system and, more particularly, to a communication apparatus and method, a recording medium, a program, and a content providing system which facilitate the acquisition of content.

When acquiring content (predetermined texts, video data, image data, audio data, game programs, and so on) via the Internet for example, each user starts a browsing program (or a browser) to search for a site holding desired content, or to be more specific, access a search engine site and enters a keyword associated with the desired content; for example, artist name or content title.

Then, the user accesses the site holding the desired content associated with the entered keyword referred to by the search engine site to obtain the desired content.

However, if, in order to obtain other content held in another site referred to by the site first accessed by the user, that another site holding desired content is not linked to the site first accessed by the user, the user must access the search engine site again and enter the keyword for the other desired content to go to the site holding that content.

Namely, the user must first access a search engine site every time he desires to obtain content and enter content-associated keywords, which takes much time and labor for each user to obtain desired content.

### SUMMARY OF THE INVENTION

It is therefore an object of the present invention to provide a communication apparatus and method, a recording medium, a program, and a content providing system which allow each user to obtain desired content with simple operations.

In carrying out the invention and acceding to one aspect thereof, there is provided a content providing system having a terminal and a server. The terminal comprises a selector for selecting search information from presentation information presented to a user; a search information transmitter for transmitting the search information selected by the selecting means to the server; and a content data receiver for receiving content data corresponding to the search information supplied from the server. The server comprises a storage device for storing the content data corresponding to the search information; a searcher for searching the storage means for the content data corresponding to the search information supplied from the search information transmitter of the terminal; and a content data transmitter for transmitting the content data retrieved from the storage information to the terminal.

In carrying out the invention and according to another aspect thereof, there is provided a communication apparatus comprising: a display section capable of displaying at least text information; a selecting section for selecting search information from presentation information presented on the display section in response to a first user input operation; a display control section for performing control so that a menu having a transmission item for transmitting at least the search information to a remote communication apparatus in response to a second user input operation; a search information transmitting section for transmitting the search information to the remote communication apparatus in response to a third user input operation for selecting the transmission item in the menu; and a content data receiving section for receiving content data corresponding to the search information supplied from the remote communication apparatus.

### BRIEF DESCRIPTION OF THE DRAWINGS

These and other objects of the invention will be seen by reference to the description, taken in connection with the accompanying drawing, in which:

FIG. 1 is a schematic diagram illustrating an exemplary connection of a content providing system to which the present invention is applied;

FIG. 2 is an exemplary display screen of an output section 17;

FIG. 3 is a block diagram illustrating an exemplary configuration of a personal computer shown in FIG. 1;

FIG. 4 is a block diagram illustrating an exemplary functional configuration of the personal computer shown in FIG. 1;

FIG. 5 is a flowchart describing a processing procedure for starting a content acquisition program;

FIG. 6 is another exemplary display screen of the output section 17;

FIG. 7 is still another exemplary display screen of the output section 17;

FIG. 8 is yet another exemplary display screen of the output section 17;

FIG. 9 is a block diagram illustrating an exemplary functional configuration of a content server shown in FIG. 1;

FIG. 10 is a flowchart describing operations of the personal computer and the content server shown in FIG. 1;

FIG. 11 is a schematic diagram illustrating another exemplary configuration of the content providing system to which the present invention is applied;

FIG. 12 is another exemplary display screen of the output section 17;

FIG. 13 illustrates data recorded to a search server shown in FIG. 11;

FIG. 14 is an exemplary display of an operator screen shown on the output section 17;

FIG. 15 is a block diagram illustrating an exemplary functional configuration of the search server shown in FIG. 11;

FIG. 16 is a block diagram illustrating an exemplary functional configuration of an EMD server shown in FIG. 11;

FIGS. 17A and 17B illustrate data for downloading and data for streaming; and

FIG. 18 is a flowchart describing operations of the personal computer, the search server, and the EMD server shown in FIG. 11.

### DETAILED DESCRIPTION OF PREFERRED EMBODIMENTS

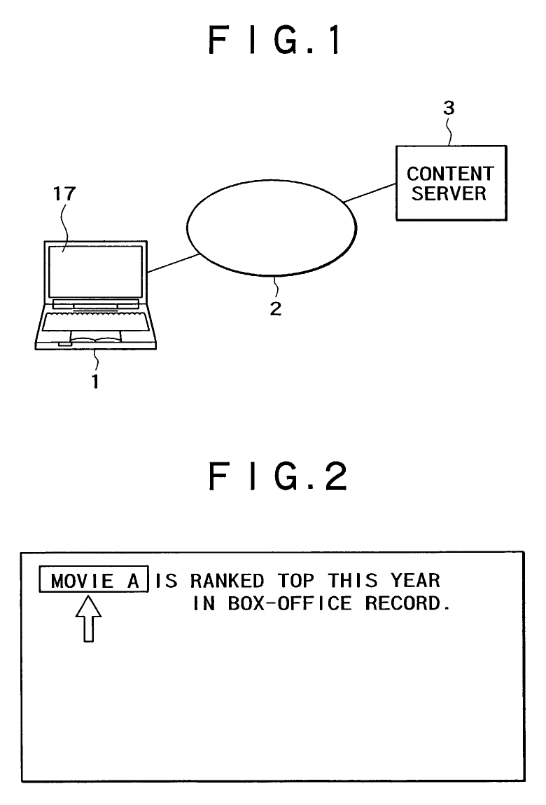

This invention will be described in further detail by way of example with reference to the accompanying drawings. Now, referring to FIG. 1, there is shown an exemplary configuration of a content providing system to which the present invention is applied.

When a predetermined character string (“MOVIE A” which is the title of movie A) for example in a sentence shown in FIG. 2 displayed on an output section 17 is selected as a keyword, a personal computer 1 sends the selected character string to a content server 3 via the Internet 2. It should be noted that the text display shown in FIG. 2 includes the text display in a wordprocessor application, an electronic mail application, and Web browser application for example. Namely, these applications may be any if that can display texts on the output section 17.

The content server 3 manages content data (the audio data and the video data for movies) on a keyword basis (for example, movie title). Receiving “MOVIE A” (keyword) from the personal computer 1, the content server 3 retrieves the content data of “MOVIE A” and sends the content data to the personal computer 1 via the Internet 2.

The personal computer 1 receives the content transmitted from the content server 3 and records or reproduces the received content.

Namely, in this content providing system, the personal computer 1 transmits the selected character string (in this example, “MOVIE A”) in the sentence displayed on the output section 17 as a keyword to the content server 3. The content server 3 searches for the content corresponding to this keyword and transmits the retrieved content to the personal computer 1. Consequently, the user of the personal computer 1 may only select a keyword from a sentence displayed on the output section 17 to obtain the desired content corresponding to the selected and entered keyword.

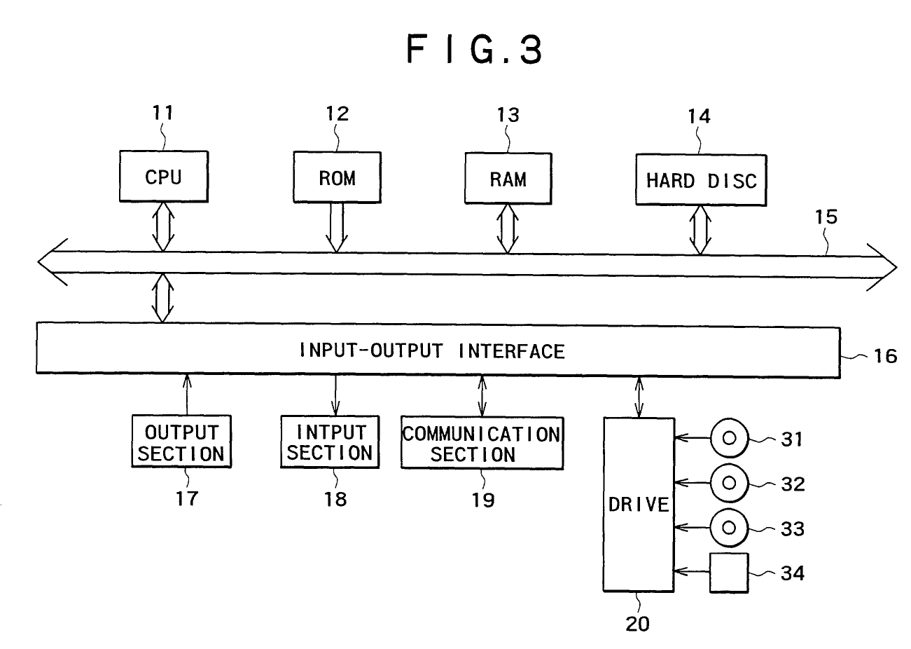

Referring to FIG. 3, there is shown a exemplary configuration of the personal computer 1. A CPU (Central Processing Unit) 11 is connected to an input/output interface 16 via a bus 15. When a command is inputted by the user through an input section 18 constituted by a keyboard and a mouse for example, the CPU 11 executes a program stored in a ROM (Read Only Memory) 12, a hard disk 14, or such a recording medium loaded in a drive 20 as a magnetic disk 31, an optical disk 32, a magneto-optical disk 33, or a semiconductor memory 34 by loading the program into a RAM (Random Access Memory) 13. By this, various processing operations described below are executed. In addition, the CPU 11 outputs the results of these processing operations to an output section 17 constituted by a LCD (Liquid Crystal Display) and a speaker for example via the input/output interface 16, on an as required basis.

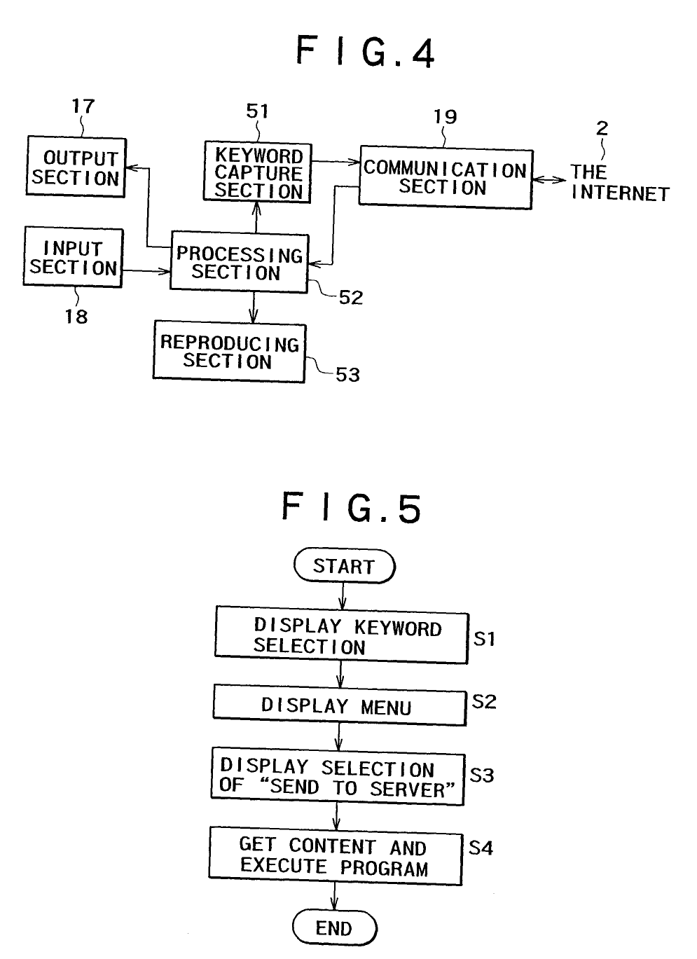

Referring to FIG. 4, there is shown an exemplary functional configuration of a content acquisition program which is executed for the CPU 11 of the personal computer 1 to use the content providing system. In this example, a keyword acquisition section 51, a processing section 52, and a reproducing section 53 constitute the functional block of the CPU 11. Obviously, each of these sections may be processed by different hardwares and, especially, a decoder IC and a speaker for the reproducing section 53 may be arranged on the personal computer 1.

First, a processing procedure for starting the content acquisition program will be described with reference to the flowchart shown in FIG. 5.

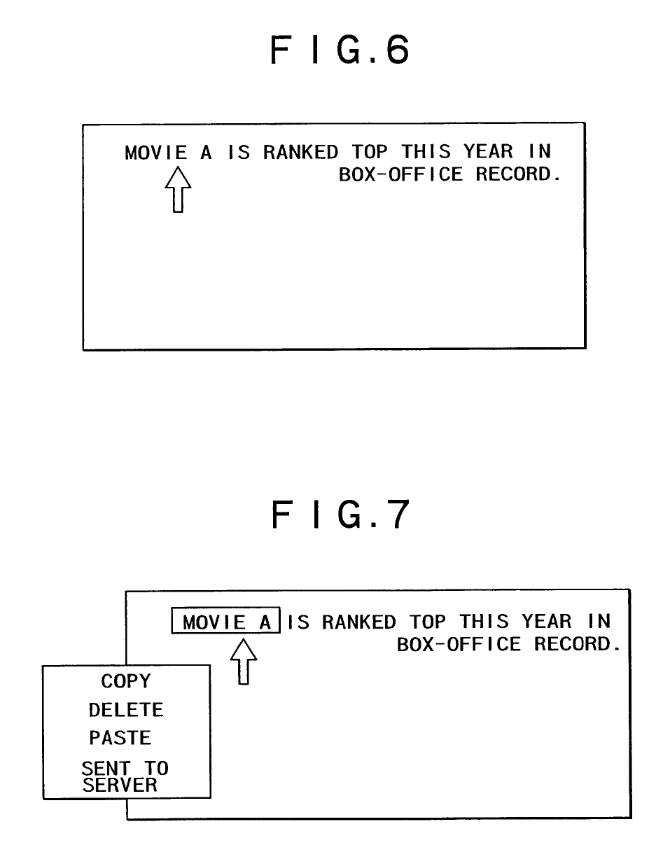

In step S1, when the left button of the mouse of the input section 18 is clicked with the pointer pointing at a character string of a sentence displayed on the output section 17 as shown in FIG. 6 for example, the processing section 52 detects the pointed character string and controls the output section 17 to display the detected character string in a reverse video manner. This allows the user to recognize that this reverse-video character string has been selected as a keyword.

In step S2, when the right button of the mouse is clicked with the keyword (“MOVIE A”) selected as shown in FIG. 2, the processing section 52 controls the output section 17 to display a menu including “SEND TO SERVER” as shown in FIG. 7. This menu may be a popup menu (namely, a pull-down menu or a pull-up menu) for example.

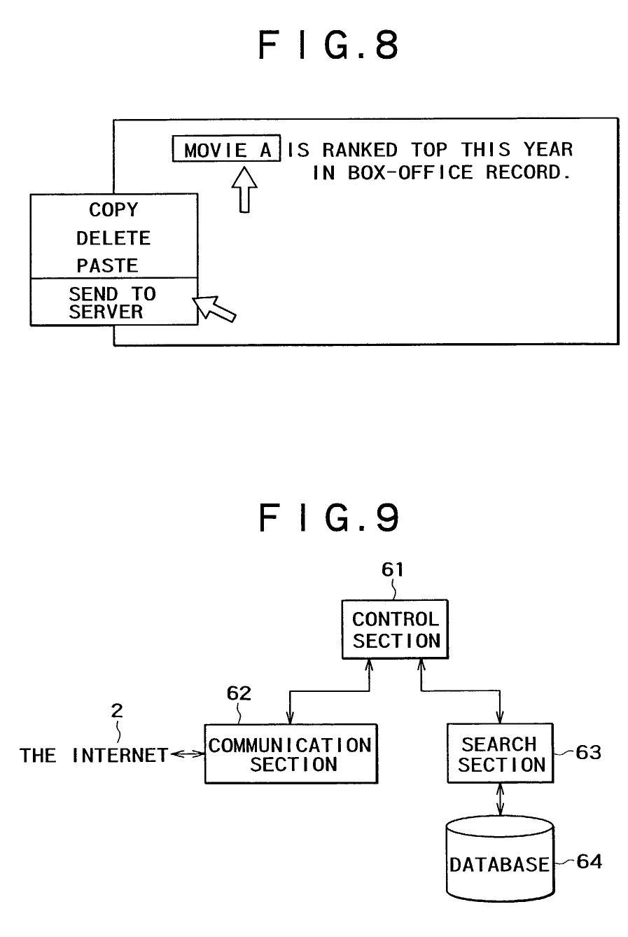

In step S3, when “SEND TO SERVER” is selected in the menu displayed in step S2, then the processing section 52 controls the output section 17 to display “SEND TO SERVER” in the menu in reverse video as shown in FIG. 8 and, in step S4, starts executing the content acquisition program.

When the content acquisition program starts, the keyword acquisition section 51 (FIG. 4) of this program gets, as a keyword, the character string “MOVIE A” selected when “SEND TO SERVER” in the menu was selected as shown in FIG. 8 and supplies the keyword to a communication section 19. The communication section 19 sends the keyword supplied from the keyword acquisition section 51 to the content server 3 via the Internet 2.

The processing section 52 converts the content data corresponding to the keyword (“MOVIE A”) transmitted from the communication section 19 and supplied from the content server 3 into the content data which can be reproducible on the reproducing section 53 for example and then supplies the converted content data to the reproducing section 53. The reproducing section 53 reproduces the supplied content data or the converted content data.

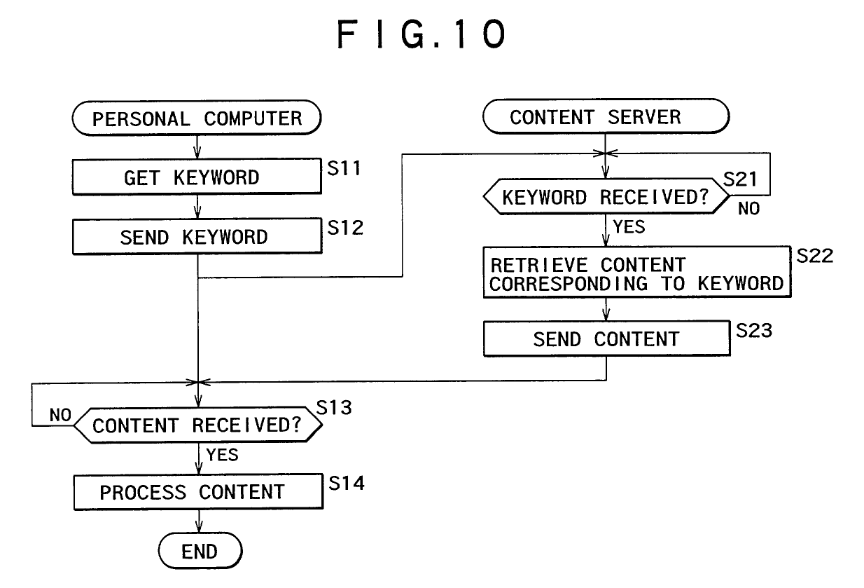

Referring to FIG. 9, there is shown an exemplary functionally configuration of the content server 3.

A communication section 62 receives the keyword supplied from the personal computer 1 and supplies the received keyword to a control section 61. The communication section 62 also sends the content data, corresponding to a keyword retrieved by a search section 63 supplied from the control section 61, to the personal computer 1 via the Internet 2.

A database 64 manages content data on a keyword basis. Namely, the search section 63 references the database 64 to retrieve the content data corresponding to the keyword supplied from the personal computer 1 via the control section 61 and supplies the retrieved content data to the control section 61.

The following describes the operations of personal computer 1 (or the content acquisition program) and the content server 3 with reference to the flowchart shown in FIG. 10.

It is assumed in this example that “SEND TO SERVER” in the menu has been selected with “MOVIE A” in the sentence displayed on the output section 17 of the personal computer 1 selected as a keyword as shown in FIG. 8.

Namely, in step S11, the keyword acquisition section 51 of the personal computer 1 gets “MOVIE A” as a keyword and, in step S12, sends the keyword to the content server 3 via the communication section 19.

In step S13, the personal computer 1 waits until the content data to be transmitted from the content server 3 in step S23 to be described later come.

In step S21, the content server 3 (or the control section 61) until the communication section 62 receives the keyword (“MOVIE A”) transmitted from the personal computer 1 in step S12. When the keyword is received, the procedure goes to step S22.

In step S22, the control section 61 of the content server 3 retrieves, from the database 64 via the search section 63, the content data corresponding to the keyword (“MOVIE A”).

In step S23, the control section 61 of the content server 3 controls the communication section 62 to send the content data retrieved in step S22 to the personal computer 1. Then, the control section 61 returns to step S21 to repeat the above-mentioned processing therefrom.

In step S13, upon reception of the content data supplied from the content server 3 in step S23, the personal computer 1 (or the processing section 52) goes to step S14 to perform predetermined processing on the received content data. For example, the processing section 52 performs control so as to store the received content data into the hard disk 14 or supplies the content data to the reproducing section 53. If the received content data are compressed data for example, the processing section 52 may decompress the content data before supplying to the reproducing section 53.

Then, the above-mentioned sequence of processing operations comes to an end.

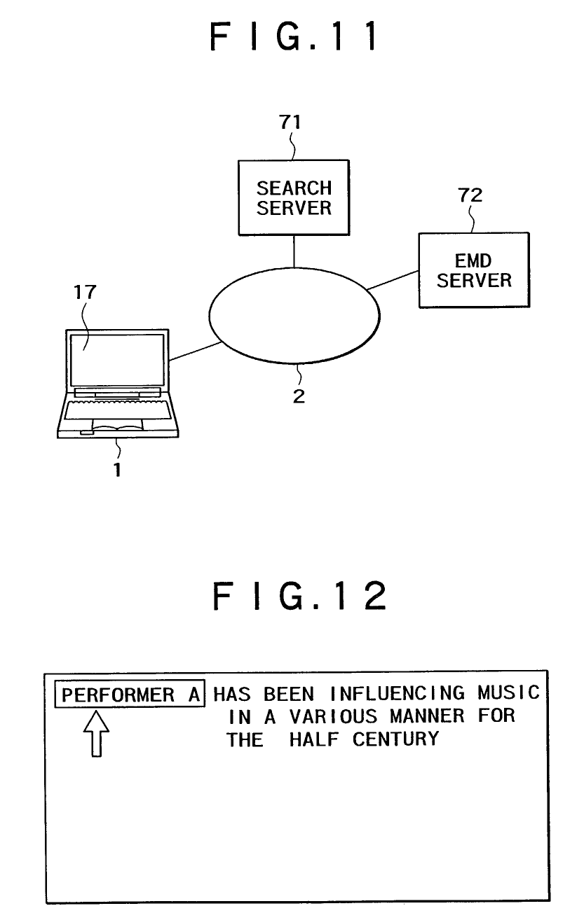

Referring to FIG. 11, there is shown another exemplary configuration of the content providing system to which the present invention is applied.

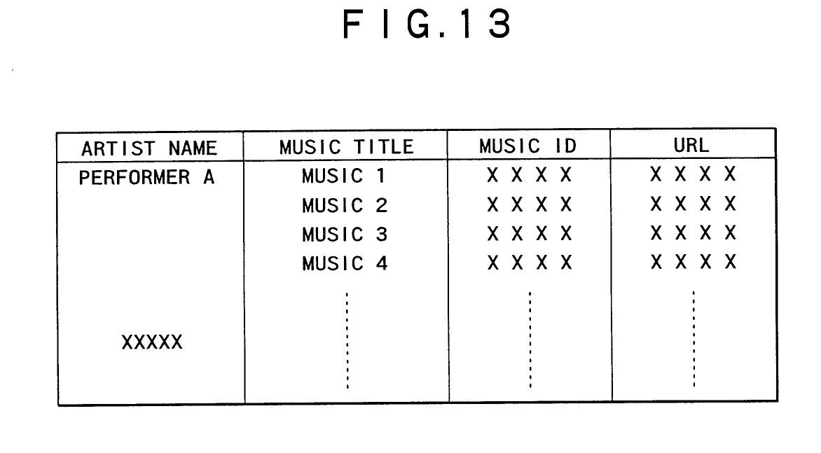

When character string (“PERFORMER A”) in a sentence shown in FIG. 12 for example displayed on the output section 17 is selected as a keyword, the personal computer 1 sends the selected character string to a search server 71 via the Internet 2.

As shown in FIG. 13, the search server 71 manages, in correspondence to an artist name, which is the keyword in this example, such information associated with the artist name as music title and music ID, and the address (in this example, URL (Uniform Resource Locator) of a server managing the music data.

Upon reception of the artist name (or the keyword) from the personal computer 1, the search server 71 retrieves the accompanying information (music title and music ID) corresponding to the artist name and the URL of the server managing the music data and sends the retrieved accompanying information and URL to the personal computer 1.

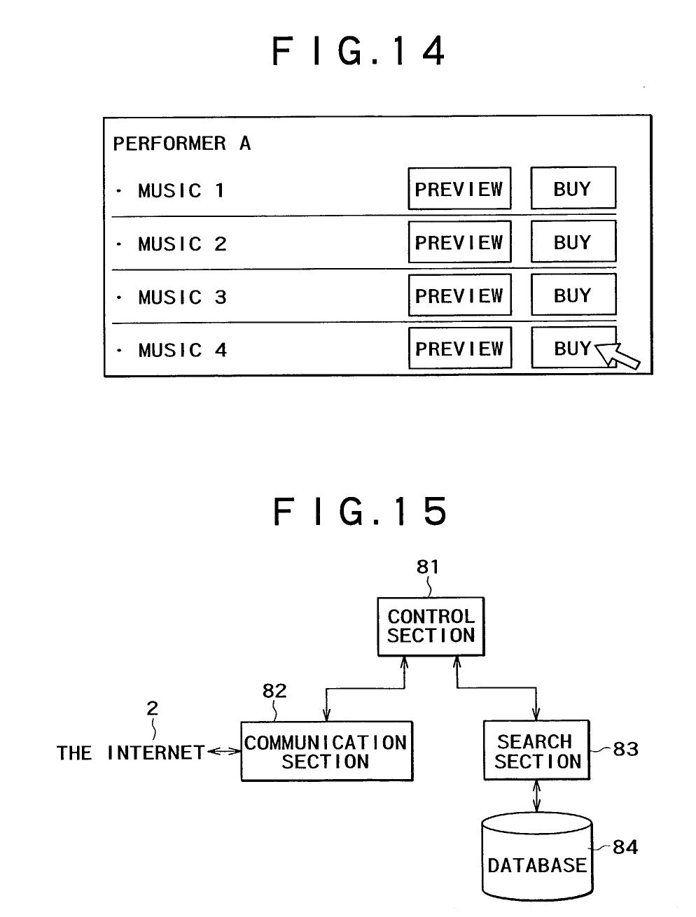

On the basis of the information received from the search server 71, the processing section 52 causes the output section 17 to display an operator screen shown in FIG. 14 for example. The operator screen shown in FIG. 14 shows artist name (“PERFORMER A”), music titles (MUSIC 1 through MUSIC 4), PREVIEW buttons for test-listening these music titles, and BUY buttons for ordering these music titles.

For example, the processing section 52 performs control so as to temporarily store, on a keyword basis, into the hard disk 14 or the RAM 13 the URL managing music titles, music IDs, and music data returned from the search server 71. When a PREVIEW button or a BUY button on the operator screen shown in FIG. 14 is operated, the processing section 52 identifies the URL of the server (in this example, an EMD server 72) managing the music data corresponding to the operated button on the basis of the temporarily stored information and controls the communication section 19 to send the music ID of the corresponding the operation done on the operator screen and a signal indicative of the test-listening or purchase of that music title.

The EMD server 72 manages music data on a music ID basis. Upon reception of the music ID and the signal for test-listening or purchase from the personal computer 1, the EMD server 72 retrieves the music data corresponding to the music ID and generates the music data for test-listening or purchase from the retrieved music data, sending the generated music data to the personal computer 1.

It should be noted that the music data for test-listening are not encrypted but added with predetermined control information for restricting the number of times the music data may be reproduced, for example. The music data for purchase are encrypted but decrypted by a key to be given on the basis of the results of fee-charge processing to be separately executed.

The personal computer 1 receives the music data (the music data for test-listening or purchase) from the EMD server 72 to record or reproduce the received data.

Namely, in the present content providing system, the personal computer 1 sends the selected character string (in this example, artist name) in the sentence shown on the output section 17 to the search server 71 as a keyword. The search server 71 retrieves the URL of the EMD server 72 managing the content data corresponding to that keyword. The personal computer 1 sends the keyword to the EMD server 72 from which the URL has been retrieved by the search server 71. The EMD server 72 sends the content data corresponding to the received keyword to the personal computer 1. Consequently, the user of the personal computer 1 may only select a keyword from a sentence displayed on the output section 17 to access the server (in this example, the EMD server 72) which manages the content data corresponding to the selected keyword, thereby obtaining desired content.

Referring to FIG. 15, there is shown an exemplary functional configuration of the search server 71.

A communication section 82 receives the keyword (artist name) from the personal computer 1 and sends it to a control section 81 and sends the URL managing the accompanying information and music data corresponding to the artist name retrieved by a search section 83 to the personal computer 1 via the Internet 2.

A database 84 holds the information shown in FIG. 13. Namely, the search section 83 retrieves from the database 84 the accompanying information (music title and music ID) and music data corresponding to the keyword (artist name) supplied from the personal computer 1 via the control section 81 and supplies the retrieved URL to the control section 81.

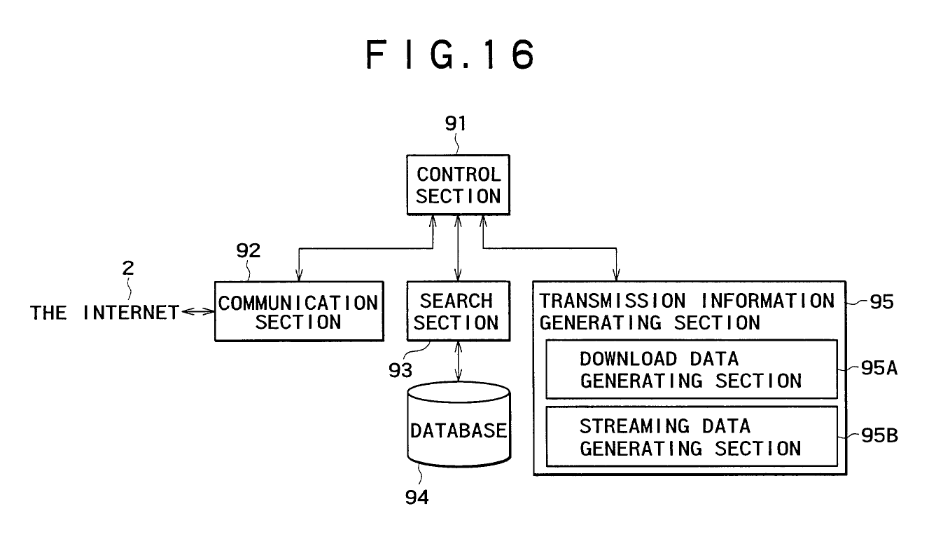

Referring to FIG. 16, there is shown an exemplary functional configuration of the EMD server 72.

A communication section 92 receives the music ID and signal indicative of test-listening or purchase from the personal computer 1 and sends them to a control section 91. The communication section 92 also sends the music data for test-listening or purchase generated by a transmission information generating section 95 and supplied via the control section 91 to the personal computer 1 via the Internet 2.

A database 94 manages music data on a music ID basis. Namely, a search section 93 retrieves the music data corresponding to the music ID sent from the personal computer 1 and supplied from the control section 91 from the database 94 and supplies the retrieved music data to the control section 91.

The transmission information generating section 95 has a download data generating section 95A and a streaming data generating section 95B.

The download data generating section 95A puts the data supplied from the control section 91 into a packet based on a highly reliable communication protocol, TCP (Transmission Control Protocol)/IP (Internet Protocol) and generates the data to be downloaded. The streaming data generating section 95B puts the data supplied from the control section 91 into a packet based on UDP (User Datagram Protocol)/IP, which prioritize communication speed over communication reliability, and generates the data to be streamed-reproduced.

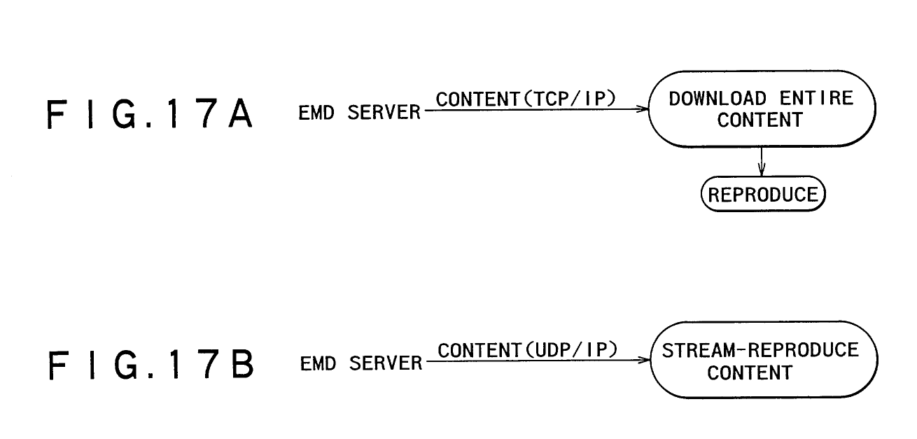

The download data are supplied as the music data to be purchased or the streaming data are supplied as the music data for test-listening to the personal computer 1 via the Internet 2. If the download data are supplied, the personal computer 1 reproduces the music data after all of the content data have been downloaded (for example, into a recording medium such as the hard disk 14) as shown in FIG. 17A.

On the other hand, if the steaming data are supplied, the personal computer 1 reproduces the content data while they are being supplied as shown in FIG. 17B (for example, the streaming data are directly reproduced without being stored in a recording medium such as the hard disk 14. However, the data which are reproduced via an audio buffer based on DRAM are included in the streaming data.)

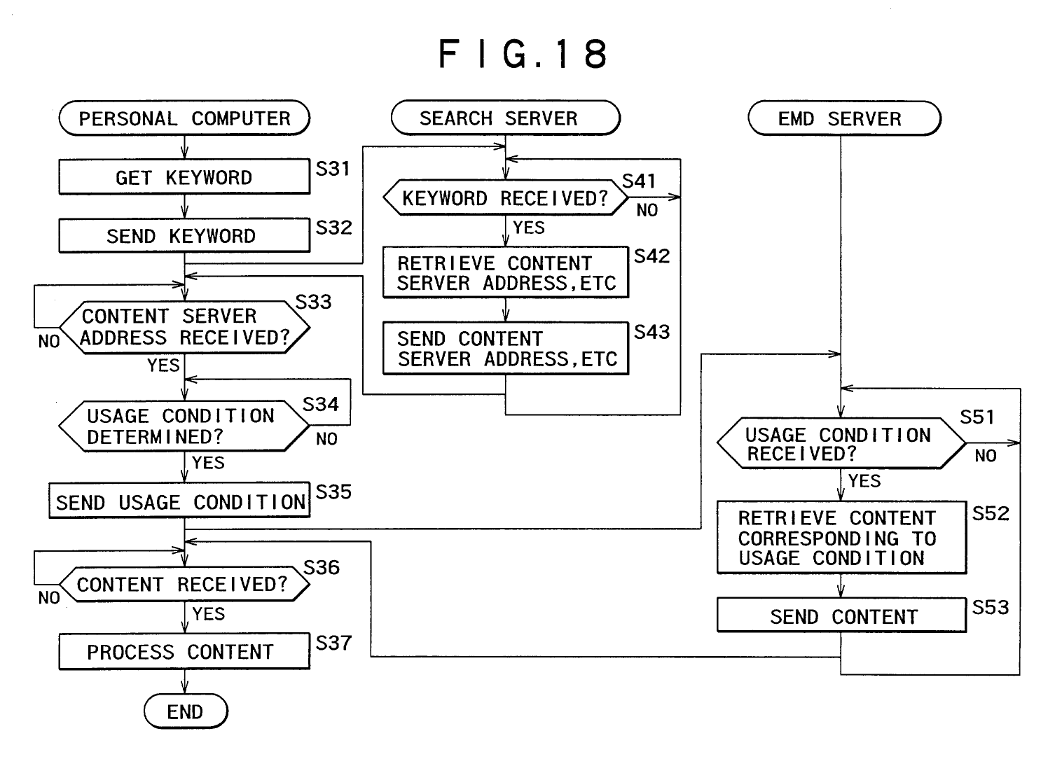

The following describes the operations of the personal computer 1 (or the content acquisition program), the search server 71, and the EMD server 72 with reference to the flowchart shown in FIG. 18. It should be noted that the content acquisition program of the personal computer 1 is executed along the processing procedure shown in the flowchart shown in FIG. 5. It is assumed here that “SEND TO SERVER” in the menu be selected with “PERFORMER A”, which is the artist name in the sentence displayed on the output section 17 of the personal computer 1, selected as a keyword.

In step S31, the keyword acquisition section 51 (FIG. 4) of the personal computer 1 gets selected “PERFORMER A” (artist name) as a keyword and sends it to the search server 71 via the communication section 19 in step S32.

In step S33, the personal computer 1 waits for the information to be supplied from the search server 71 in step S43 to be described later.

In step S41, the search server 71 (the control section 81) waits for the communication section 82 to receive the keyword from the personal computer 1 in step S32 and, upon its reception, goes to step S42.

In step S42, the control section 81 of the search server 71 retrieves, from the database 84 (FIG. 13), the URL of the server (in this example, EMD server 72) which manages the accompanying information (music title and music ID) and music data corresponding to the received keyword (in this example, PERFORMER A as artist name).

In step S43, the control section 81 of the search server 71 controls the communication section 82 to send the accompanying information (music title and music ID) retrieved in step S42 and the URL of the EMD server 72 managing the music data to the personal computer 1. Then, the control section 81 returns to step S41 to repeat the above-mentioned processing therefrom.

When the information transmitted from the search server 71 in step S43 is received in step S33, the personal computer 1 (or the processing section 52) goes to step S34 to wait until the music ID is determined and whether to test-listen or purchase that music is determined (hereafter, the contents determined here are referred to as usage conditions). Namely, at this moment, the processing section 52 controls the output section 17 to display an operator screen as shown in FIG. 14 on the basis of the accompanying information (music title and music ID) corresponding to the artist name and the URL of the EMD server 72 managing the music data supplied from the search server 71 and waits until the operator screen is operated by the user.

If the usage conditions (the music ID and the test-listening or purchase of that music) are determined in step S34, namely if any of the PREVIEW buttons or BUY buttons on the operator screen shown in FIG. 14 is operated, then the procedure goes to step S35.

In step S35, the processing section 52 of the personal computer 1 detects the URL of the EMD server 72 managing the music data corresponding to the PREVIEW button or the BUY button operated in step S34 from the information supplied from the search server 71 in step S33 and accesses the EMD server 72 having the detected URL, sending the music ID of the music corresponding to the operated button and a signal indicative of the test-listening or purchase of that music. Namely, the usage conditions are transmitted to the EMD server 72.

In step S36, the personal computer 1 waits until the content data are supplied from the EMD server 72 in step S53 to be described later.

In step S51, the EMD server 72 (or the control section 91) waits until the usage conditions (the music ID and the signal indicative of test-listening or purchase) are received. Upon reception of the usage conditions, the procedure goes to step S52.

In step S53, the control section 91 of the EMD server 72 controls the search section 93 to retrieve the music data (content) corresponding to the received music ID from the database 94.

In step S53, the control section 91 of the EMD server 72 controls the transmission information generating section 95 to generate the data for transmission (download data or streaming data) corresponding to the signal indicative of test-listening or purchase received in step S51 on the basis of the music data retrieved in step S52 and controls the communication section 92 to send the generated data for transmission to the personal computer 1.

If the signal supplied from the personal computer 1 indicates purchase, the control section 91 of the EMD server 72 controls the download data generating section 95A of the transmission information generating section 95 to generate download data and send them to the personal computer 1.

On the other hand, if the signal supplied from the personal computer 1 indicates test-listening, the control section 91 of the EMD server 72 controls the streaming data generating section 95B of the transmission information generating section 95 to generate streaming data and send them to the personal computer 1.

Then, back in step S51, the EMD server 72 repeats the above-mentioned processing therefrom.

Upon reception, in step S36, of the music data supplied from the EMD server 72 in step S53, the personal computer 1 (or the processing section 52) goes to step S37 to perform predetermined processing on the received music data. For example, if the download data are supplied, reproduction processing is started after the downloading of the entire content data. If the streaming data are supplied, streaming reproduction is performed.

Then, the above-mentioned sequence of processing operations comes to an end.

It should be noted that the OS (Operating System) of the personal computer 1 may be adapted to have the functionality of the content acquisition program or a browser program may be adapted to have that functionality. Alternatively, this functionality may reside as a program for adding the functionality to the OS and, when a predetermined operation (for example, simultaneous pressing of a special key such as CTRL key and a character key) is performed with the predetermined character string selected, this program supplies the selected character string to the OS as a keyword, thereby causing the OS to perform the above-mentioned sequence of processing operations.

In the above-mentioned embodiment, content is music data for example. It will be apparent that the present invention is also applicable if content is language dictionary information (Japanese dictionary, Japanese-to-English dictionary, English-to-Japanese dictionary, etc.) for example.

The above-mentioned sequence of processes may be executed by hardware as well as by software. To execute the above-mentioned processing by software, the programs constituting the software are installed from recording media into a computer assembled in a dedicated hardware device or a general-purpose personal computer which can execute various capabilities by installing various programs.

The recording media are constituted not only by package media such as the magnetic disk 31 (including a floppy disk), the optical disk 32 (including CD-ROM (Compact Disk-Read Only Memory) and a DVD (Digital Versatile Disk)), and the magneto-optical disk 33 (including MD (Mini Disk) (trademark), and the semiconductor memory 34 (including Memory Stick) which are distributed to users to provide programs independently of computers as shown in FIG. 3, but also by the ROM 12 and the hard disk 14 storing programs to be provided to users as installed in computers in advance.

It should be noted that the steps for describing programs to be recorded in recording media include not only the processing operations which are executed in a time dependent manner in the order described, but also the processing operations which are executed in parallel to each other or discretely from each other.

It should also be noted that term system as used herein denotes an entire apparatus constituted by two or more components.

In the content providing system shown in FIG. 11, the accompanying information for content data is supplied to the personal computer 1 from the search server 71 in response to the transmission of an artist name as a keyword from the personal computer 1 to the search server 71, for example. It will be apparent that the keyword is not always an artist name; any information capable of identifying content data may be used. If the database 94 of the EMD server 72 stores content data classified by genre, season, or age, genre information, season information, or age information may be used as the keyword. If the search server 71 manages attribute information corresponding to a plurality of content data, the content providing system shown in FIG. 11 may be adapted to send to the personal computer 1 the identification information of the content data corresponding to the attribute information hit by the full text search base don the keyword supplied from the personal computer 1.

While the preferred embodiments of the present invention have been described using specific terms, such description is for illustrative purposes only, and it is to be understood that changes and variations may be made without departing from the spirit or scope of the appended claims.

What is claimed is:

1. A content providing system having a terminal and a server,
said terminal comprising:
selecting means for selecting search information from presentation information presented to a user;
search information transmitting means for transmitting said search information selected by said selecting means to said server; and
content data receiving means for receiving content data corresponding to said search information supplied from said server;
said server comprising:
storage means for storing said content data corresponding to said search information;
searching means for searching said storage means for said content data corresponding to said search information supplied from said search information transmitting means of said terminal; and
content data transmitting means for transmitting said content data retrieved from said storage information to said terminal.

2. The content providing system according to claim 1, wherein said terminal has a display control section for controlling a display section in accordance with a user operation done in response to said presentation information displayed on said display section;
in said terminal,
said selecting means selecting said search information from said presentation information displayed on said display section in response to a first user input operation;
said display control means displaying, on said display section, a menu having a transmit-to-server item for transmitting at least said search information to said server in response to a second user input operation; and
said search information transmitting means transmits said search information to said server in response to a third user input operation for selecting said transmit-to-server item in said menu.

3. The content providing system according to claim 2, wherein said search information transmitting means transmits title information of content data as said search information; and
said search means searches said storage means for said content data on the basis of said title information.

4. The content providing system according to claim 2, wherein said display control means has a copy item for copying a text selected by said selecting means in addition to said transmit-to-server item for transmitting said search information to said server in response to said second user input operation.

5. The content providing system according to claim 1, wherein a Web browser application is installed on said terminal and said presentation information is displayed in a window of said Web browser application.

6. The content providing system according to claim 1, wherein said terminal further has a processing means for processing said content data received by said content data receiving means.

7. The content providing system according to claim 6, wherein said processing means includes a recording control means for recording said received content data into at least one of an internal recording medium and an external recording medium.

8. The content providing system according to claim 6, wherein said processing means includes a decompressing means for decompressing said received content data which are compressed and a reproducing means for reproducing said decompressed data supplied from said decompressing means.

9. A content providing system having a terminal, a search server, and a content server,
said terminal comprising:
selecting means for selecting search information from presentation information presented to a user;
search information transmitting means for transmitting said search information selected by said selecting means to said server;
address and content data identification information receiving means for receiving an address of said content server managing content data associated with said search information and content data identification information for identifying said content data associated with said search information, said content data being supplied from said search server;
content data identification information transmitting means for accessing said content server on the basis of said address received by said address and content data identification information receiving means and transmitting said content data identification information; and
content data receiving means for receiving said content data identified by said content data identification information supplied from said content server;
said search server comprising:
address and content data identification information storage means for storing, in correspondence to said search information, said address of said content server managing said content data associated with said search information and said identification information for said content data;
address and content data identification information searching means for searching, on the basis of said search information supplied from said search information transmitting means of said terminal, said address and content data identification information storage means for said address of said content server managing said content data associated with said search information and said content data identification information for identifying said content data associated with said search information; and
address and content data identification information transmitting means for transmitting said address and content data identification information retrieved by said address and content data identification information searching means;
said content server comprising:
content data storage means for storing said content data in correspondence to said content data identification information;
content data identification information receiving means for receiving said content data identification information supplied from said content data identification information transmitting means of said terminal;
content data searching means for searching said content data storage means for said content data on the basis of said content data identification information; and
content data transmitting means for transmitting said content data retrieved by said content data searching means to said terminal.

10. The content providing system according to claim 9, wherein, in said terminal,
said address and content data identification information receiving means further receives title information for said content data along with said address and content data identification information;
said terminal further comprising a display means for displaying said title information;
said content data identification information transmitting means transmitting said content data identification information in response to a user input operation for said title information displayed on said display means.

11. The content providing system according to claim 10, wherein said content data identification information transmitting means transmits one of purchase request information for requesting purchase of said content data and test-listening request information for requesting test-listening said content data in response to a user input operation to said content server;
said content server further comprises:
a purchase data generating section for converting said content data retrieved by said content data searching means into purchase data;
a test-listening data generating section for converting said content data into test-listening data; and
upon request from said content data identification information transmitting means, a control means for performing control such that said content data are converted by one of said purchase data generating section and said test-listening data generating section.

12. The content providing system according to claim 11, wherein said purchase data generating section converts said content data into TCP/IP protocol data; and
said test-listening data generating section converts said content data into UDP/IP protocol data.

13. The content providing apparatus according to claim 11, wherein said purchase data generating section encrypts said content data; and
said test-listening data generating section adds, to said content data, control information for restricting the number of times said content data may be reproduced.

14. A communication apparatus comprising:
a display section capable of displaying at least text information;
a selecting section for selecting search information from presentation information presented on said display section in response to a first user input operation;
a display control section for performing control so that said display section displays a menu having a transmission item for transmitting at least said search information to a remote communication apparatus in response to a second user input operation;
a search information transmitting section for transmitting said search information to said remote communication apparatus in response to a third user input operation for selecting said transmission item in said menu; and
a content data receiving section for receiving content data corresponding to said search information supplied from said remote communication apparatus.

15. The communication apparatus according to claim 14, wherein said search information transmitting section transmits title information of content data as said search information and said content data receiving section receives content data corresponding to said title information.

16. The communication apparatus according to claim 14, wherein said display control section has a copy item for copying text selected by said selecting section in response to said second user input operation in addition to said transmission item for transmitting said search information to said remote communication apparatus.

17. The communication apparatus according to claim 14, wherein said search information transmitting section transmits identification information for said content data as said search information;
further comprising a title information receiving section for receiving title information of content data corresponding to said search information supplied from said remote communication apparatus;
said display control section performs control so that said display section displays said title information received by said title information receiving section;
said search information transmitting section transmits at least one of said title information and content data identification information corresponding to said title information in response to a user input operation for said title information to said remote communication apparatus.

18. The communication apparatus according to claim 14, wherein a Web browser application is installed on said communication apparatus; and
said selecting section selects said search information from said presentation information inside a window of said Web browser application displayed on said display section.

19. The communication apparatus according to claim 14, further comprising a processor for processing said content data received by said content data receiving section.

20. The communication apparatus according to claim 19, wherein said processor includes a recording controller for recording said received content data to at least one of an internal storage medium and an external storage medium.

21. The communication apparatus according to claim 19, wherein said processor includes a decompressing section for decompressing said received content data which are compressed and a reproducing section for reproducing said decompressed data supplied from said decompressing section.

22. A communication apparatus comprising:
a content data storage section for storing content data for each content data identification information;
a content data identification information receiving section for receiving said content data identification information and one of purchase information and test-listening information supplied from a remote communication apparatus;
a content data searching section for searching said content data storage section for content data on the basis of said content data identification information;
a purchase data generating section for converting said content data retrieved by said content data searching section into purchase data;
a test-listening data generating section for converting said content data retrieved by said content data searching section into test-listening data;
a controller for performing control such that said content data are converted by one of said purchase data generating section and said test-listening data generating section, in response to one of purchase request information and test-listening request information supplied from said content data identification information receiving section; and
a content data transmitting section for transmitting said converted content data to said remote communication apparatus.

23. The communication apparatus according to claim 22, wherein said purchase data generating section converts said content data into TCP/IP protocol data; and
said test-listening data generating section converts said content data into UDP/IP protocol data.

24. The communication apparatus according to claim 22, wherein said purchase data generating section encrypts said content data; and
said test-listening data generating section adds, to said content data, control information for restricting the number of times said content data may be reproduced.

25. A communication method comprising the steps of:
displaying at least text information onto a display section;
selecting search information from presentation information presented on said display section in response to a first user input operation;
controlling said display section to display a menu having a transmission item for transmitting at least said search information to a remote communication apparatus in response to a second user input operation;
transmitting said search information to said remote communication apparatus in response to a third user input operation for selecting said transmission item in said menu; and
receiving, from said remote communication apparatus, content data corresponding to said search information supplied.

26. A communication method comprising the steps of:
receiving content data identification information and one of purchase request information and test-listening request information supplied from a remote communication apparatus;
searching a content data storage section from content data on the basis of said content data identification information;
converting said retrieved content data into one of purchase data and test-listening data in response to received one of said purchase request information and said test-listening request information; and
transmitting said converted content data to said remote communication apparatus.

27. A program for communication method comprising the steps of:
displaying at least text information onto a display section;
selecting search information from presentation information presented on said display section in response to a first user input operation;
controlling such that said display section displays a menu having a transmission item for transmitting at least said search information to a remote communication apparatus in accordance with a second user input operation;
transmitting said search information to said remote communication apparatus in response to a third user input operation for selecting said transmission item in said menu; and
receiving, from said remote communication apparatus, content data corresponding to said search information.

28. A program for a communication method comprising the steps of:
receiving content data identification information and one of purchase request information and test-listening request information from a remote communication apparatus;
searching a content data storage section for content data on the basis of said content data identification information;
converting said retrieved content data into one of purchase data and test-listening data in response to received one of said purchase request information and said test-listening information; and
transmitting said converted content data to said remote communication apparatus.

29. A recording medium recording a program for a communication method comprising the steps of:
displaying at least text information onto a display section;
selecting search information from presentation information presented on said display section in response to a first user input operation;
controlling such that said display section displays a menu having a transmission item for transmitting at least said search information to a remote communication apparatus in accordance with a second user input operation;
transmitting said search information to said remote communication apparatus in response to a third user input operation for selecting said transmission item in said menu; and
receiving, from said remote communication apparatus, content data corresponding to said search information.

30. A recording medium recording a program for a communication method comprising the steps of:
receiving content data identification information and one of purchase request information and test-listening request information from a remote communication apparatus;
searching a content storage section for content data on the basis of said content data identification information;
converting said retrieved content data into one of purchase data and test-listening data in response to received one of said purchase request information and said test-listening information; and
transmitting said converted content data to said remote communication apparatus.
